(19) United States
(12) Patent Application Publication
(10) Pub. No.: US 2015/0005915 A1
(43) Pub. Date: Jan. 1, 2015

(54) COMPUTING DEVICE AND METHOD FOR GENERATING MANUFACTURING PROGRAM OF PRODUCT FOR CNC MACHINE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); LU YANG, Shenzhen (CN)

(21) Appl. No.: 14/318,682

(22) Filed: Jun. 29, 2014

(30) Foreign Application Priority Data
Jun. 28, 2013 (CN) 2013102640169

(51) Int. Cl. G05B 19/4097

(52) U.S. Cl. CPC G05B 19/4097; G05B 2219/31418
USPC 700/97

(57) ABSTRACT

In a method for generating manufacturing program of a product for computer numerically controlled (CNC) machine, a graphic file of a product is read, and lines of the graphic file are extracted. The method generates a point cloud according to the lines of the graphic file, the point cloud includes a plurality of points that together represent the lines. A quantity of the points of each of the lines can be adjusted according to a curvature of each line, and an optimized point cloud is output. The method generates a CNC program for manufacturing the product according to the optimized point cloud and a CNC template program.

### FIELD

The subject matter herein generally relates to data optimization.

### BACKGROUND

The use of computer numerically controlled (CNC) machines is widespread. The CNC machine reads a numerical control (NC) program or “cutting file” stored in a memory of the CNC machine in order to cut a workpiece (such as a product). The cutting file directs the CNC machine with respect to where and how the workpiece is to be cut, whether the cuts are in a straight line or curved.

### BRIEF DESCRIPTION OF THE DRAWINGS

Implementations of the present technology will now be described, by way of example only, with reference to the attached figures.

FIG. 1 is a block diagram of one embodiment of a computing device including a program generating unit.

FIG. 2 is a graphic of a product read by a graphic read module of the computing device shown in FIG. 1.

FIG. 3 is a view of the graphic shown in FIG. 2 with normal vectors shown.

FIG. 4 is similar to FIG. 3, but showing the inward-looking vectors of FIG. 3 reversed.

FIG. 5 is a representation of a point cloud of the graphic shown in FIG. 4.

FIG. 6 is a view of two marked points of the point cloud shown in FIG. 5.

FIG. 7 is a flowchart illustrating one embodiment of a method for generating a manufacturing program of a product using the computing device of FIG. 1.

FIG. 8 is a detailed description of block 202 in FIG. 7.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

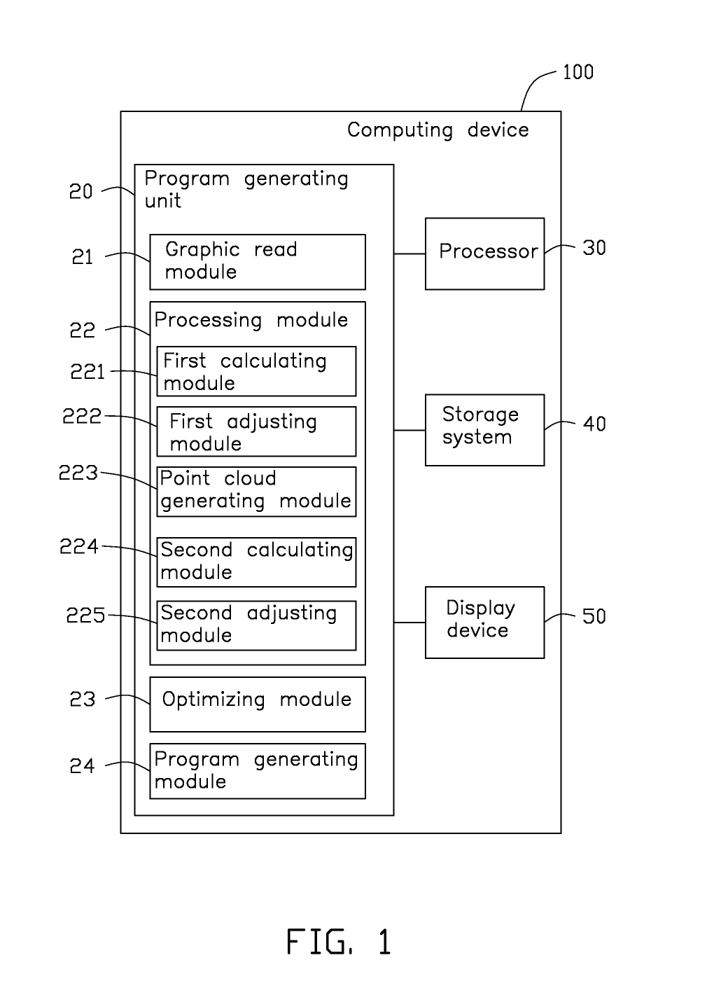

FIG. 1 illustrates one embodiment of a computing device 100 including a program generating unit 20. The computing device 100 further includes at least one processor 30, a storage system 40, and a display device 50. In one embodiment, the computing device 100 may be a computer, a server, a portable electronic device, or other data processing device. Functions of the program generating unit 20 are implemented by the computing device 100. The program generating unit 20 may be a software program stored in the storage system 40 and executed by the processor 30.

In one embodiment, the storage system 40 may be a magnetic or an optical storage system, such as a hard disk drive, an optical drive, a compact disc, a digital video disc, a tape drive, or other storage medium. The processor 30 may be a central processing unit including a math co-processor, for example.

In one embodiment, the program generating unit 20 includes a graphic read module 21, a processing module 22, an optimizing module 23, and a program generating module 24. Each of the modules 21-24 may be a software program including one or more computerized instructions that are stored in the storage system 40 and executed by the processor 30.

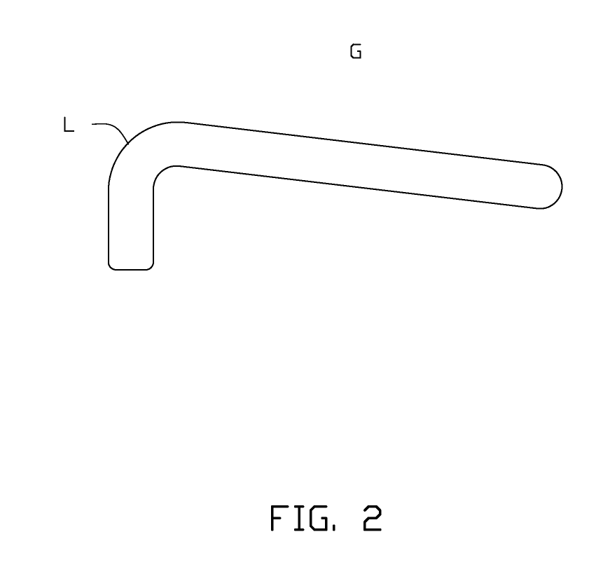

The graphic read module 21 reads a graphic file, such as a computer-aided design (CAD) file, of a product, and extracts outlines and dimensions of the product from the graphic file. The graphic file can be stored in the storage system 40 and edited by an operator. The graphic file of the product includes a plurality of lines, such as straight lines and curves. For example, FIG. 2 illustrates one embodiment of a graphic file of a product entitled “G” read by the graphic read module 21 shown in FIG. 1. As illustrated in FIG. 2, the graphic file of product G includes a plurality of lines L, the lines included in L include straight lines and curves.

The processing module 22 generates a point cloud according to the lines of the graphic file of the product. The point cloud includes a plurality of points that together represent the lines. In detail, the processing module 22 includes a first calculating module 221, a first adjusting module 222, a point cloud generating module 223, a second calculating module 224, and a second adjusting module 225.

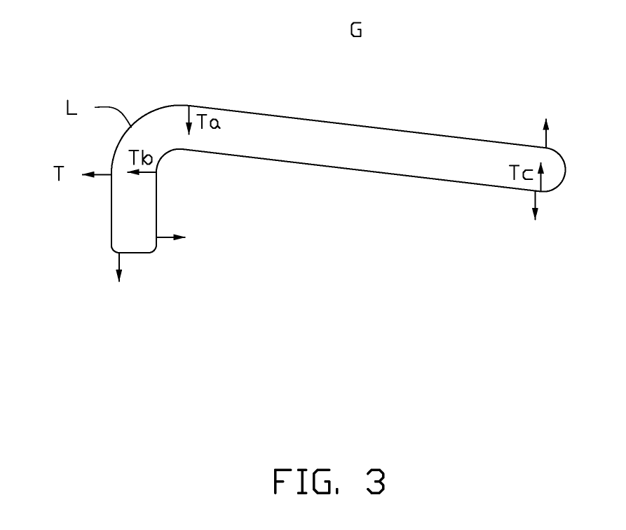

The first calculating module 221 calculates a normal vector of each line. For example, FIG. 3 illustrates normal vectors T shown on the graphic file of FIG. 2. As illustrated in FIG. 3, the normal vectors T all have different directions, some of the normal vectors T (such as normal vectors Ta, Tb, and Tc) point towards interior of the graphic file of the product, and the other normal vectors T point towards outside of the graphic file of the product.

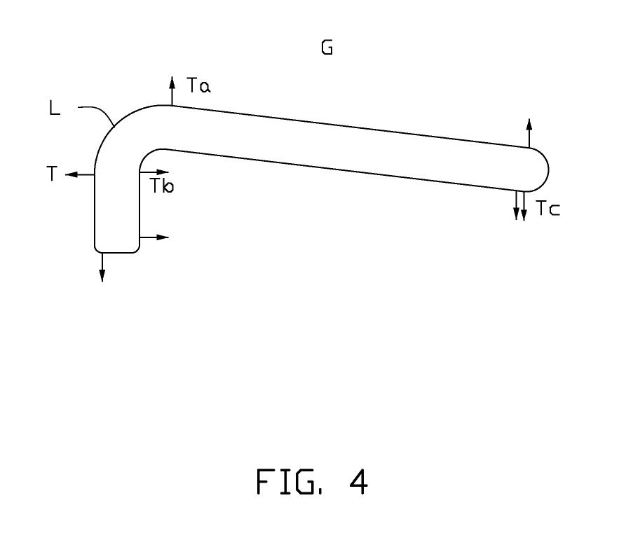

The first adjusting module 222 adjusts the normal vectors to ensure that every normal vector points towards outside of the graphic file. In detail, the first adjusting module 222 firstly calculates an angle between a first normal vector that points towards outside of the graphic file and a second normal vector that is immediately adjacent to the first normal vector, and determines whether or not to reverse the second normal vector according to the calculated angle. If the calculated angle is greater than 90 degrees, the first adjusting module 222 reverses the second normal vector. If the calculated angle is less than 90 degrees, indicating that the second normal vector already points towards outside of the graphic, and the first adjusting module 222 does not reverse the direction of the second normal vector. The first adjusting module 222 then calculates an angle between the second normal vector and an adjacent third normal vector and determines whether or not to reverse the third normal vector according to the angle between the second normal vector and the third normal vector. The first adjusting module 222 repeats the aforementioned steps until all normal vectors point towards outside of the graphic. For example, referring to FIG. 4, the normal vectors Ta, Tb, and Tc in FIG. 3 have been reversed and point towards outside of the graphic file of the product G as shown in FIG. 4.

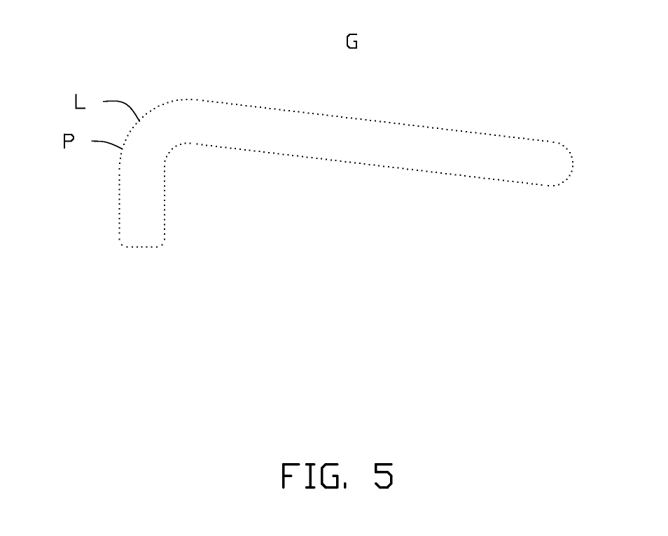

The point cloud generating module 223 generates the point cloud according to the lines. Each line is represented by a plurality of points that are evenly spaced from each other at predetermined intervals. For example, as shown in FIG. 5, one of the lines L is represented by a plurality of spaced points P.

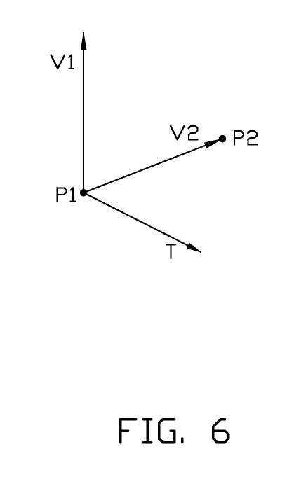

The second calculating module 224 calculates an actual vector of each point of the point cloud. The actual vector of each point is defined as a cross product of an ordinal vector and the normal vector of a line that includes the point. The ordinal vector is a vector that has a direction from the point towards an adjacent point. For example, as illustrated in FIG. 6, an actual vector V1 of a point P1 is a cross product of an ordinal vector V2 and the normal vector T of a line that includes the point P1. The ordinal vector V2 has a direction from the first point P1 towards a point P2 immediately adjacent to the point P1.

The second adjusting module 225 adjusts the actual vectors of the points to ensure that each actual vector points towards outside of the graphic file. In detail, the second adjusting module 225 first calculates an angle between a first actual vector that points towards outside of the graphic file and a second actual vector that is immediately adjacent to the first actual vector, and determines whether or not to reverse the second actual vector according to the calculated angle. If the angle is greater than 90 degrees, the second adjusting module 225 reverses the second actual vector. If the angle is less than 90 degrees, indicating that the second actual vector already points towards outside of the graphic file, and the second adjusting module 225 does not reverse the direction of the second actual vector. The second adjusting module 225 then calculates an angle between the second actual vector and an adjacent third actual vector, and determines whether or not to reverse the third actual vector according to the angle between the second actual vector and the third actual vector.

The second adjusting module 225 repeats the aforementioned steps until all actual vectors point towards outside of the graphic file.

The optimizing module 23 adjusts a quantity of the points of each line according to a curvature of each line, and outputs an optimized point cloud. In detail, the optimizing module 23 calculates an angle between actual vectors of a first point and an adjacent second point, and eliminates the first point when an angular curvature is less than a predetermined curvature. Otherwise, when the angular curvature is greater than the predetermined curvature, the first point is retained, and the optimizing module 23 calculates an angle between the actual vectors of the second point and a third adjacent point to determine whether the second point should be eliminated. The optimizing module 23 repeats the aforementioned steps until all of the lines of the point cloud are optimized. As a result, the lines with a lesser curvature include a lesser number of points, and other lines with a greater curvature include a greater number of points.

The program generating module 24 generates a CNC program for manufacturing the product according to the optimized point cloud and a CNC template program. The CNC template program can be stored in the storage system 40. A CNC machine can read the CNC program and cut a product along the lines represented by the points. The program generating module 24 further outputs the CNC program to the display device 50.

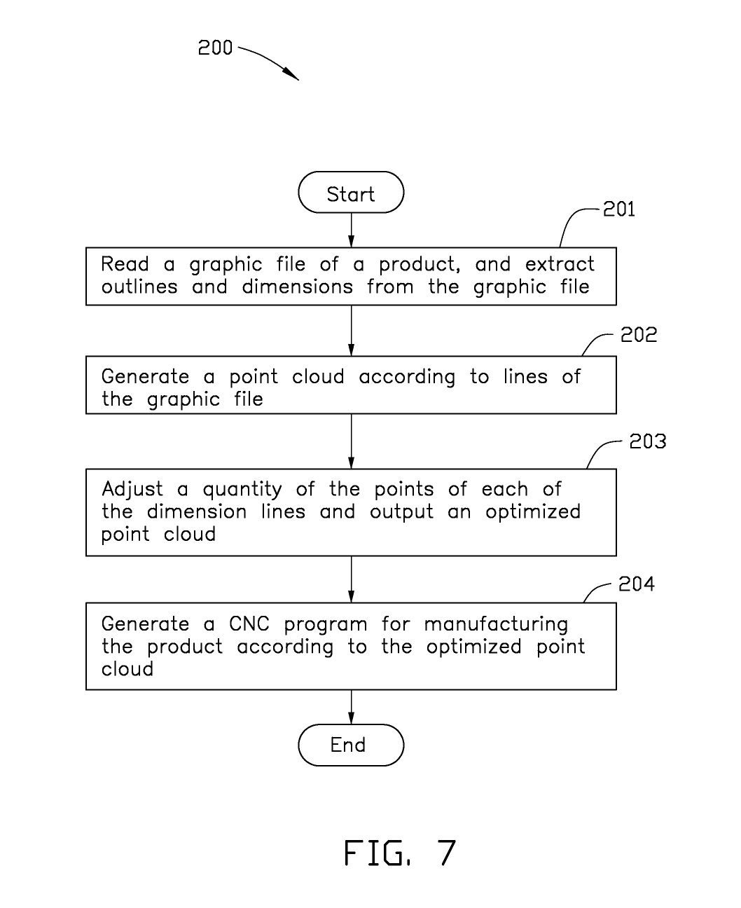

Referring to FIG. 7, a flowchart for this example embodiment is illustrated. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 6 represents one or more processes, methods, or subroutines, carried out in the exemplary method 200. Additionally, the illustrated order of blocks is by example only and the order of the blocks can change. The exemplary method 200 can begin at block 201.

At block 201, the graphic read module reads a graphic file, such as a computer aided design (CAD) graphic file of a product, and extracts outlines and dimensions of the product. The graphic file can be stored in the storage system and edited by an operator. The graphic file of the product includes a plurality of lines which can be straight or curved.

At block 202, the processing module generates a point cloud according to the lines of the graphic file of the product. The point cloud includes a plurality of points representing the lines. In other words, each line includes a plurality of points. The processing module can calculate a normal vector of each line and an actual vector of each point.

At block 203, the optimizing module adjusts a quantity of the points of each line according to a curvature of each line, and outputs an optimized point cloud. In detail, the optimizing module calculates an angle between actual vectors of a first point and an adjacent second point, and eliminates the first point when an angular curvature is less than a predetermined curvature. Otherwise, when the angular curvature of the angle is greater than the predetermined curvature, the first point is retained, and the optimizing module calculates an angle between the actual vectors of the second point and a third adjacent point to determine whether the second point should be eliminated. The optimizing module repeats the aforementioned steps until all of the lines of the point cloud are optimized. As a result, the lines with a lesser curvature include a lesser number of points, and other lines with a greater curvature include a greater number of points.

At block 204, the program generating module generates a CNC program for manufacturing the product according to the optimized point cloud and a CNC template program. The program generating module further outputs the CNC program to the display device.

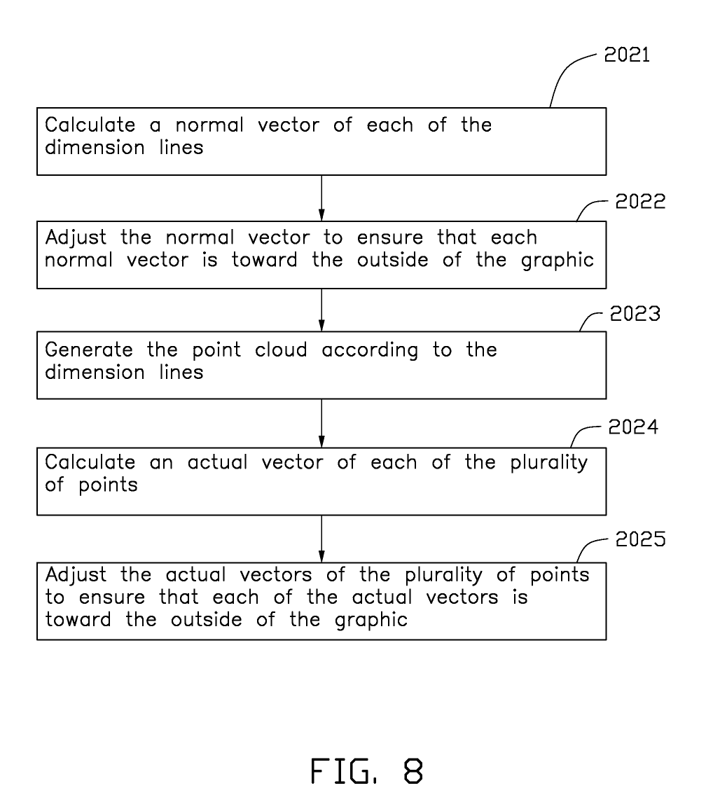

FIG. 8 illustrates a detailed description of block 202. Depending on the embodiment, additional blocks can be added, others removed, and the ordering of the blocks can be changed.

At block 2021, the first calculating module calculates a normal vector of each of the lines.

At block 2022, the first adjusting module adjusts the normal vectors to ensure that each normal vector points towards outside of the graphic file. In detail, the first adjusting module calculates an angle between a first normal vector that points towards outside of the graphic file and a second normal vector that is immediately adjacent to the first normal vector, and determines whether or not to reverse the second normal vector according to the calculated angle. If the angle is greater than 90 degrees, the first adjusting module reverses the second normal vector. If the angle is less than 90 degrees, indicating that the second normal vector already points towards outside of the graphic, and the first adjusting module does not reverse the direction of the second normal vector. The first adjusting module then calculates an angle between the second normal vector and an adjacent third normal vector, and determines whether or not to reverse the third normal vector according to the angle between the second normal vector and the third normal vector. The first adjusting module repeats the aforementioned steps until all normal vectors point towards outside of the graphic.

At block 2023, the point cloud generating module generates the point cloud according to the lines. Each line is represented by a plurality of points that are evenly spaced from each other at predetermined intervals.

At block 2024, the second calculating module calculates an actual vector of each point of the point cloud. The actual vector of each point is defined as a cross product of an ordinal vector and the normal vector of a line that includes the point. The ordinal vector is a vector that has a direction from the point towards an adjacent point.

At block 2025, the second adjusting module adjusts the actual vectors of the points to ensure that each actual vector points towards outside of the graphic file. In detail, the second adjusting module calculates an angle between a first actual vector that points towards outside of the graphic file and a second actual vector that is immediately adjacent to the first actual vector, and determines whether or not to reverse the second actual vector according to the calculated angle. If the angle is greater than 90 degrees, the second adjusting module reverses the second actual vector. If the angle is less than 90 degrees, indicating that the second actual vector is already toward outside of the graphic file, and the second adjusting module does not reverse the direction of the second actual vector. The second adjusting module then calculates an angle between the second actual vector and an adjacent third actual vector, and determines whether or not to reverse the third actual vector according to the angle between the second actual vector and the third actual vector. The second adjusting module repeats the aforementioned steps until all actual vectors point towards outside of the graphic file.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A computing device comprising:
at least one processor;
a storage system; and
one or more modules that are stored in the storage system and executed by the at least one processor, the one or more modules comprising:
a graphic read module that reads a graphic file of a product, and extracts outlines and dimensions of the graphic file, wherein the graphic file comprises a plurality of lines;
a processing module that generates a point cloud according to the lines of the graphic file, the point cloud comprising a plurality of points that together represent the lines;
an optimizing module that adjusts a quantity of the points of each of the lines according to a curvature of each line, and outputs an optimized point cloud; and
a program generating module that generates a computer numerically controlled (CNC) program for manufacturing the product according to the optimized point cloud and a CNC template program.

2. The computing device of claim 1, wherein the processing module comprises:
a first calculating module that calculates a normal vector of each of the lines;
a first adjusting module that adjusts the normal vector to ensure that each normal vector points towards outside of the graphic file;
a point cloud generating module that generates the point cloud according to the lines;
a second calculating module that calculates an actual vector of each of the plurality of points; and
a second adjusting module that adjusts the actual vectors of the plurality of points to ensure that each of the actual vectors points towards outside of the graphic file.

3. The computing device of claim 2, wherein the first adjusting module executes following steps to adjust the normal vector to ensure that each normal vector points towards outside of the graphic file:
calculating an angle between a first one of the normal vectors that points towards outside of the graphic file and an adjacent second one of the normal vectors; and
reversing the direction of the second one of the normal vectors upon the condition that the calculated angle is greater than ninety degrees.

4. The computing device of claim 2, wherein the actual vector of each of the plurality of points is a cross product of an ordinal vector and the normal vector of a line that including the point; the ordinal vector has a direction from the point towards an adjacent point.

5. The computing device of claim 4, wherein second adjusting module executes following steps to adjust the actual vectors of the plurality of points to ensure that each of the actual vectors points towards outside of the graphic file:
calculating an angle between a first one of the actual vectors that points towards outside of the graphic file and an adjacent second one of the actual vectors; and
reversing the direction of the second one of the actual vectors upon the condition that the calculated angle is greater than ninety degrees.

6. The computing device of claim 5, wherein the optimizing module executes following steps to adjust a quantity of the points of each of the lines:
calculating an angle between actual vectors of a first one of the plurality of points and an adjacent second one of the plurality of points; and
eliminating the first one of the plurality of points upon the condition that when an angular curvature is less than a predetermined curvature.

7. A computer-implemented method for generating manufacturing program of a product for computer numerically controlled (CNC) machine using a computing device, the method comprising:
reading a graphic file of a product, and extracting outlines and dimensions of the graphic file, wherein the graphic file comprises a plurality of lines;
generating a point cloud according to the lines of the graphic file, the point cloud comprising a plurality of points that together represent the lines;
adjusting a quantity of the points of each of the lines according to a curvature of each line, and outputting an optimized point cloud; and
generating a CNC program for manufacturing the product according to the optimized point cloud and a CNC template program.

8. The method of claim 7, wherein the step of generating the point cloud comprises:
calculating a normal vector of each of the lines;
adjusting the normal vector to ensure that each normal vector points towards outside of the graphic file;
generating the point cloud according to the lines;
calculating an actual vector of each of the plurality of points; and
adjusting the actual vectors of the plurality of points to ensure that each of the actual vectors points towards outside of the graphic file.

9. The method of claim 8, wherein the step of adjust the normal vector comprises:
calculating an angle between a first one of the normal vectors that points towards outside of the graphic file and an adjacent second one of the normal vectors; and
reversing the direction of the second one of the normal vectors upon the condition that the calculated angle is greater than ninety degrees.

10. The method of claim 8, wherein the actual vector of each of the plurality of points is a cross product of an ordinal vector and the normal vector of a line that including the point; the ordinal vector has a direction from the point towards an adjacent point.

11. The method of claim 10, wherein the step of adjusting the actual vectors of the plurality of points comprises:
calculating an angle between a first one of the actual vectors that points towards outside of the graphic file and an adjacent second one of the actual vectors; and
reversing the direction of the second one of the actual vectors upon the condition that the calculated angle is greater than ninety degrees.

12. The method of claim 11, wherein the step of adjusting a quantity of the points of each of the lines comprises:
calculating an angle between actual vectors of a first one of the plurality of points and an adjacent second one of the plurality of points; and
eliminating the first one of the plurality of points upon the condition that when an angular curvature is less than a predetermined curvature.

13. A non-transitory computer-readable medium having stored thereon instructions that, when executed by a processor of a computing device, causes the computing device to perform a method for generating manufacturing program of a product for computer numerically controlled (CNC) machine, the method comprising:
calculating a normal vector of each of the lines;
adjusting the normal vector to ensure that each normal vector points towards outside of the graphic file;
generating the point cloud according to the lines;
calculating an actual vector of each of the plurality of points; and
adjusting the actual vectors of the plurality of points to ensure that each of the actual vectors points towards outside of the graphic file.

14. The non-transitory computer-readable medium of claim 13, wherein the step of generating the point cloud comprises:
calculating a normal vector of each of the lines;
adjusting the normal vector to ensure that each normal vector points towards outside of the graphic file;
generating the point cloud according to the lines;
calculating an actual vector of each of the plurality of points; and
adjusting the actual vectors of the plurality of points to ensure that each of the actual vectors points towards outside of the graphic file.

15. The non-transitory computer-readable medium of claim 14, wherein the step of adjust the normal vector comprises:
calculating an angle between a first one of the normal vectors that points towards outside of the graphic file and an adjacent second one of the normal vectors; and
reversing the direction of the second one of the normal vectors upon the condition that the calculated angle is greater than ninety degrees.

16. The non-transitory computer-readable medium of claim 14, wherein the actual vector of each of the plurality of points is a cross product of an ordinal vector and the normal vector of a line that including the point; the ordinal vector has a direction from the point towards an adjacent point.

17. The non-transitory computer-readable medium of claim 16, wherein the step of adjusting the actual vectors of the plurality of points comprises:
calculating an angle between a first one of the actual vectors that points towards outside of the graphic file and an adjacent second one of the actual vectors; and
reversing the direction of the second one of the actual vectors upon the condition that the calculated angle is greater than ninety degrees.

18. The non-transitory computer-readable medium of claim 17, wherein the step of adjusting a quantity of the points of each of the lines comprises:
calculating an angle between a first one of the actual vectors that points towards outside of the graphic file and an adjacent second one of the actual vectors; and
reversing the direction of the second one of the actual vectors upon the condition that the calculated angle is greater than ninety degrees.
